(19) United States
(12) Patent Application Publication
(10) Pub. No.: US 2005/0254089 A1
(43) Pub. Date: Nov. 17, 2005

(54) System and method for producing print order files customized for a particular printer

(75) Inventors: Jason R. Oliver, Rush, NY (US); Kenneth A. Parulski, Rochester, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/187,668

(22) Filed: Jul. 22, 2005

Related U.S. Application Data
(63) Continuation-in-part of application No. 09/821,184, filed on Mar. 29, 2001.
Application No. 09/821,184 is a continuation of application No. 08/977,382, filed on Nov. 24, 1997, now Pat. No. 6,573,927.
(60) Provisional application No. 60/037,963, filed on Feb. 20, 1997.

(51) Int. Cl. G06F 15/02; H04N 1/21; H04N 5/76

(52) U.S. Cl. 358/1.16; 348/231.3; 348/231.7; 348/333.02; 348/333.11; 358/1.18

(57) ABSTRACT

A method and system that is adapted to print order files that are customized for a particular printer. The method and system includes a digital printer that has specific printing capabilities and involves the production and storage of a profile that defines the printing capabilities of the printer.

### CROSS REFERENCE TO RELATED APPLICATIONS

The invention is a continuation-in-part of continuation application U.S. Ser. No. 09/821,184 filed Mar. 29, 2001 which is a continuation of U.S. Pat. No. 6,573,927 issued Jun. 3, 2003.

### FIELD OF THE INVENTION

The invention relates generally to the field of digital photography, and in particular to digital cameras and digital printers. More specifically, the invention relates to a digital camera that can print images on a range of digital printers.

### BACKGROUND OF THE INVENTION

Prior to 1997, digital cameras allowed images to be utilized on a home computer (PC) and to be incorporated into e-mail documents and personal home pages on the World Wide Web. When prints were desired, each image was first copied to the PC and then individually printed. The user was required to manually select each image to be printed, and manually decide how big each print should be and how many prints to make of each image.

At the present time, there are a wide variety of digital printing systems capable of producing prints from images captured using digital cameras. These include, for example, low cost appliance printers, such as the Kodak EasyShare Printer Dock family, that produces 4″×6″ prints and offers some special image processing features, but does not produce larger size prints. They also include ink jet printers capable of producing page-size prints as well as 4″×6″ prints. They also include kiosks, such as the Kodak Picture Maker kiosk printing system, capable of producing different size prints having multiple images per page, as well as providing various image processing enhancements. They also include on-line printing services, such as the Kodak EasyShare Gallery on-line printing service. This printing service is capable of producing prints ranging from wallet size to 20″×30″, as well as photo products such as t-shirts and mugs which include a digital image provided by the user. It would be desirable for the user of a digital camera to be able to easily take advantage of the capabilities of these different digital printing systems.

In October 1998, the now well-known digital print order format (DPOF) specification was announced by Canon, Inc. Eastman Kodak Company, Fuji Photo Film Co., Ltd., and Matsushita Electric Industrial Co. Ltd. DPOF enables a print order to be composed in a digital camera as the user reviews images. The DPOF file is then stored on a memory card along with the captured images. The memory card can then be placed in a home printer or a retail/laboratory printing system, which reads the DPOF file and produces the prints specified in the DPOF file.

The DPOF specification includes some mandatory parameters that must be supported by all DPOF printers. For example, some particular mandatory parameters indicate which images are to be printed, and the number of copies to make of each image. The DPOF specification also includes many optional parameters. These optional parameters can specify, for example, what the print size should be, whether to print the date/time on the image, and whether to print multiple images on the same page. Not all printers support these optional parameters, however. Therefore, when the user composes a DPOF print order using their digital camera, they have no way of knowing if their DPOF printer can support one of the optional parameters, such as selecting a particular print size. As a result, most digital cameras only support the DPOF mandatory parameters. This limits the usefulness of DPOF.

On Feb. 3, 2003, the well-known “PictBridge” specification was standardized as CIPA DC-001 by the Camera & Imaging Products Association in Japan. This standard defines a set of protocols and operations that enables a digital camera to create and send a print order to a printer, when the camera is directly connected to the printer via a USB Cable. PictBridge provides support for printing a single image or a collection of images, and for providing the user with ongoing status results. The DPS_gGetCapability operation enables the printer to provide its capabilities to the digital camera. These capabilities include the paper size(s), paper type(s), print quality settings, whether the printer can print the date/time or image name, whether the printer can enhance or “optimize” images, what layouts are supported by the printer, and whether the printer can crop the image prior to printing. A user interface on the PictBridge enabled camera can then adapt to the capabilities that are supported by both the camera and printer, such as selecting different paper sizes, quality settings, and layouts.

A drawback with the PictBridge camera—printer system is that the print order can only be composed when the user connects the camera to the printer. Therefore, both the camera and printer need to be in the same room. This is often inconvenient or even impossible, particularly if the printer is at a retail or wholesale printing location. Instead, it is much more desirable to enable the user to compose a print order at a location which is remote from the printer, such as during a vacation trip, at a sporting event, etc. Unfortunately, this is not possible with the PictBridge standard, which requires that the digital camera be directly connected to the PictBridge printer via a USB cable, in order to determine and therefore take advantage of the printer's capabilities.

What is needed is a way for a user to easily produce customized print order files, using only the digital camera at a location remote from the printing device, which can still take advantage of the capabilities of particular printing devices, including home printers, retail kiosk printing systems, and on-line printing services.

### SUMMARY OF THE INVENTION

The present invention relates to a method for producing prints using a digital printer from images captured using a digital camera. The method comprises: (a) providing a digital printer having specific printing capabilities; (b) producing a profile defining the printing capabilities of the digital printer; (c) storing the profile in the digital printer; (d) transferring the profile from the digital printer to the digital camera using a removable storage device; (e) capturing images using the digital camera and storing the captured images on the removable storage device; (f) using the digital camera to produce a print order using at least one printer capability of the digital printer; (g) storing the print order on the removable storage device; (h) transferring the removable storage device from the digital camera to the digital printer; and (i) printing the print order on the digital printer.

The present invention further relates to a method for producing prints from images captured by a digital camera, with the method using at least a first digital printer and a second digital printer, and the second digital printer having different capabilities than the first digital printer. The method comprises: (a) producing a first profile defining printing capabilities of the first digital printer and a second profile defining printing capabilities of the second digital printer; (b) storing the first and second profiles in the digital camera; (c) capturing and storing images using the digital camera; (d) using the digital camera and the first and second profiles to produce a first print order for the first digital printer and a second print order for the second digital printer; (e) using the first print order to produce prints using the first printer; and (f) using the second print order to produce prints on the second printer.

The present invention further relates to a method for producing prints at a service provider using images captured by a digital camera and transferred over a communications network to the service provider, which comprises (a) providing a digital camera having a modem for communicating with a service provider over the communications network; (b) the service provider using the communications network to communicate the printing capabilities of a digital printer to the digital camera; (c) capturing a digital image using the digital camera; (d) using the printing capabilities of the digital printer to create a print order in the digital camera; (e) communicating the digital image and the print order to the service provider; and (f) using the digital printer to produce a print of the digital image specified in the print order.

### BRIEF DESCRIPTION OF THE DRAWINGS

FIGS. 1A and 1B are a block diagram of a system according to the invention;

FIG. 2 is a diagram of downstream services available in the system shown in FIGS. 1A, 1B;

FIG. 3 is an illustration of one example of a creative background added to an image;

FIG. 4 is a diagram of the organization of a utilization file;

FIG. 5 is a diagram of another organization of a utilization file together with each image file;

FIGS. 6A and 6B are a block diagram of another embodiment of a system according to the invention;

FIG. 7 is a flow diagram of a first embodiment of a method for producing print order files customized for a particular printer;

FIG. 8 is a flow diagram of a second embodiment of a method for producing print order files customized for a particular printer;

FIG. 9 is a diagram listing the printer capabilities of four different printing systems; and

FIGS. 10A and 10B provide examples of two different digital camera user interfaces that are customized for the capabilities of two different digital printers.

### DETAILED DESCRIPTION OF THE INVENTION

Because imaging systems and devices are well known, the present description will be directed in particular to elements forming part of, or cooperating more directly with, an apparatus in accordance with the present invention. Elements not specifically shown or described herein may be selected from those known in the art. Some aspects of the present description may be implemented in software. Unless otherwise specified, all software implementation is conventional and within the ordinary skill in the programming arts.

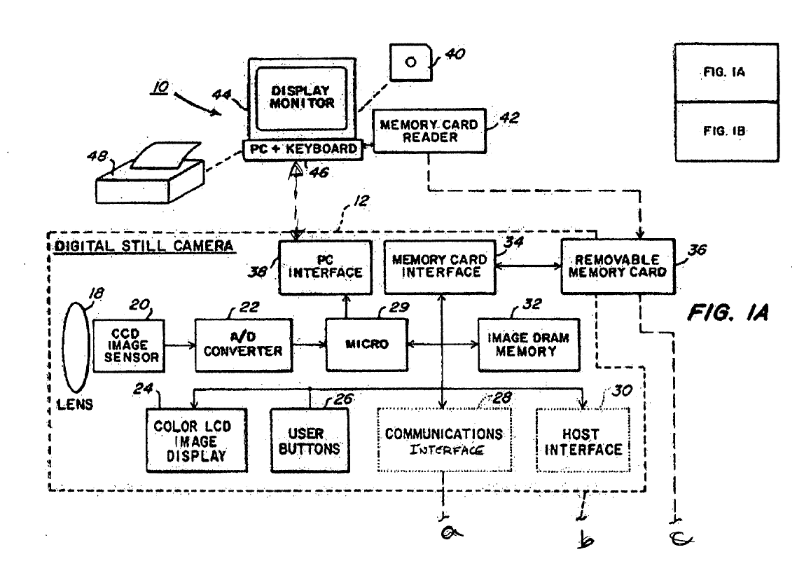

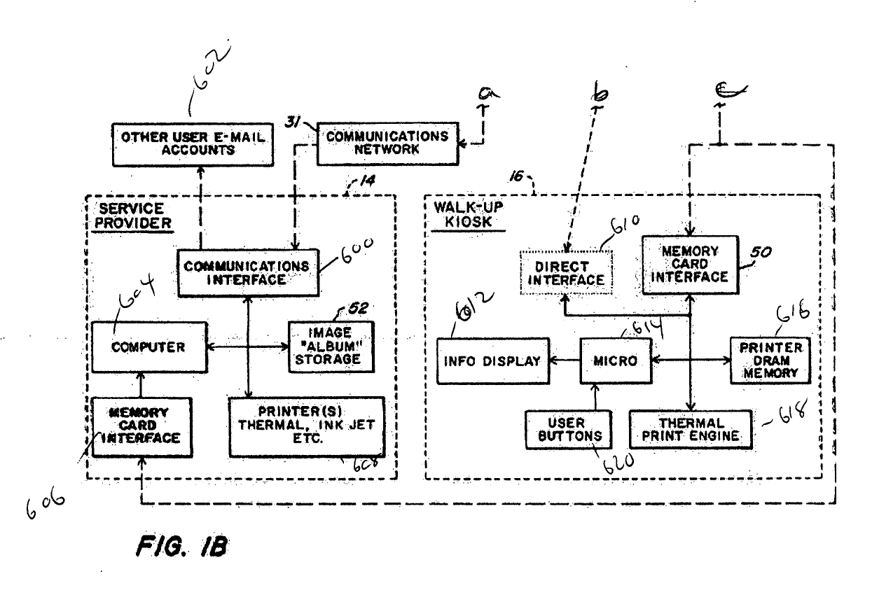

A system block diagram of the invention is shown in FIGS. 1A and 1B, and includes a user's host computer (PC) 10, a digital camera 12, equipment located at a “downstream” service provider 14, and equipment at a walk-up kiosk 16. The camera 12 includes an optical section 18 for imaging a scene upon an image sensor 20 and generating an image signal, an A/D converter 22 for digitizing the image signal, a liquid crystal display (LCD screen) 24 for displaying images and other information, a number of user input buttons 26, and both internal memory 32 and a removable memory card 36 for storing captured images. The camera may optionally include an internal communications interface 28 (e.g. modem). Also, camera 10 can include a mobile phone, a PDA, a camcorder, etc. A microprocessor 29 generally controls the operation of the camera 12, and interchanges data through a memory card interface 34 with the memory card 36, through a PC interface 38 with the host computer 10, through a host interface 30 directly with the kiosk 16, and through the communications interface 28 and a communications network 31 with the service provider 14.

Service provider 14 includes a communication interface 600 which is operationally associated with communication network 31 and is also adapted to communicate with other user e-mail accounts 602. Service provider 14 also comprises a computer 604, a memory card interface 606, at least one printer 608 (for example, a thermal printer, an inkjet printer, a photographic printer, etc.), and an image album storage 52. Walk-up kiosk 16 includes a memory card interface 50 as well as a direct interface 610, a microcomputer 614, an information display 612, a printer DRAM memory 616, user control buttons 620 and at least one printer such as, for example, a thermal print engine 618.

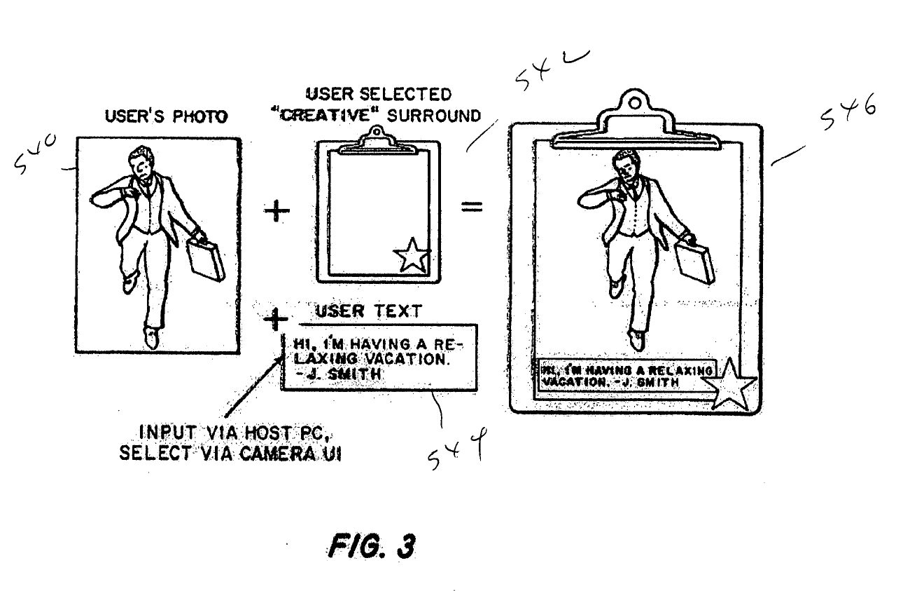

When the camera is purchased, it is provided with a software application (located on a disc 40) for running on the user's host PC 10 that enables the user to specify the name(s) of downstream service providers, network addresses (friends, family or business associates) and related account information such as billing information (charge card number, mailing addresses, etc.). The user can also select, through the software application, one or more “creative backgrounds” offered by the service provider (such as a postcard border) and enter one or more text messages, (such as “Hi, I'm having a relaxing vacation, John Smith” ), as will be described in connection with FIG. 3. All of this information can then be downloaded, via a memory card reader 42 on the host PC 10, to the removable memory card 36, which can be subsequently inserted into the camera. Alternatively, the information can be downloaded to the camera 12 via the host PC interface 38 and written to the camera's internal memory 32 or the removable memory card 36 in the camera. Typically, keyword descriptors accompany the information to enable easy access by the camera user.

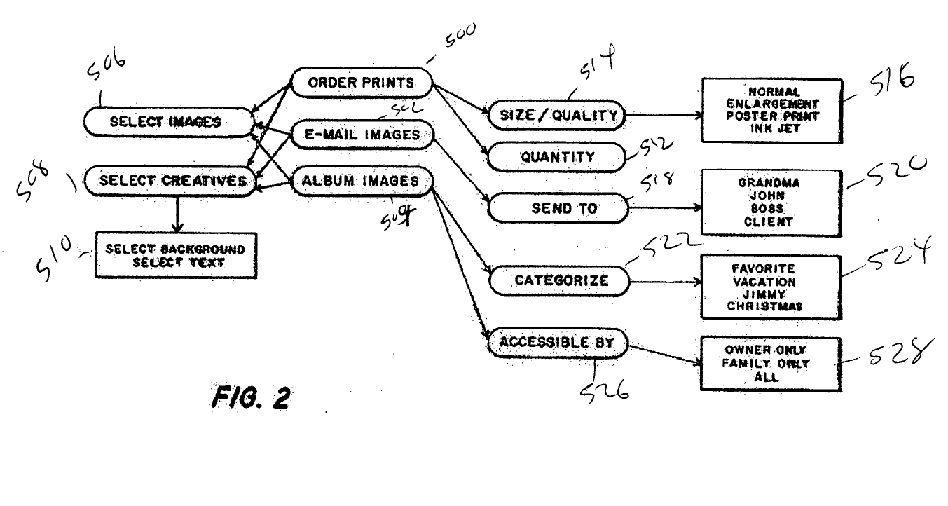

After placing the memory card 36 in the camera (or disconnecting the camera from the host PC 10), the user can operate the camera 12 to take numerous pictures, which are stored either in the internal memory 32 or in the memory card 36 (or in both). After taking pictures, the user reviews the images on the LCD screen 24, using the buttons 26 to scroll through the images. The user can then select the desired “downstream services” (such as printing 500, e-mailing 502, and/or albuming 504) as shown in FIG. 2, and compose the order using the options listed in FIG. 2. For example, as illustrated in FIG. 2, the options can include the user selection of images 506, the user selection of creatives 508, and the user selection of background and text 510.

These services and options are accessed from the memory card 36 and, for example, the keyword descriptors are assembled in a menu and displayed on the LCD screen 24. Selections among these services and options are made, for example, by reference to the keyword descriptors and actuation of the user buttons 26. The details of the order information is written into a “utilization” file generated by the camera that identifies the order and includes pointers to the image files that store the images required to “fulfill” the order. The “utilization” file is stored in the internal memory 32 or the memory card 36.

As also shown in FIG. 2, for printing, order composition involves selecting the quantity 512, as well as print size and quality level 514 (e.g., thermal or ink jet) of the images to be printed. For example, the user might choose one “standard” (4″×6″ size) image of 2 different images, and 2 standard size images plus one “enlargement” (8″×10″ size) image of their “favorite” vacation image. The print order information is provided in the utilization file that identifies the order and includes pointers to the image files that store the images required to “fulfill” the print order. In addition to “normal” type prints, the prints can be “creative” prints, using one of the creative backgrounds selected on the host computer and downloaded to the camera along with text. In this case, the “favorite” image might be surrounded with one of the border and captions provided via the host PC 10, as shown in FIG. 3. As further options, once size/quality 514 is selected, a user can choose to print a normal size image, an enlargement, a poster print or an ink jet print (516). If the user decides to e-mail images, he/she can specify who the images are to be sent to (518, 520). If the user decides to place the images in an album, the user can categorize the images with different designations; and also determine who would have access to the images 526, 528.

As noted above, in the example of FIG. 3, a user image 540 can be combined with a user selected creative surround 542 and user text 444 that is inputted via the host computer or the camera interface to create an image 546 having a border and text.

The user can then take or mail the image memory card 36 containing the image files and order information (utilization file) to the print service provider 14. The provider reads the information, fills the print order, and returns the print order either for pick-up by the user or by mail. The service provider 14 charges the user's credit card account (which can be stored in the print order information file) for the prints provided. Alternately, the user can place the card 36 in a slot or memory card interface 50 of a “walk-up kiosk” 16 (FIG. 1B) along with a credit card. The kiosk can then automatically produce the prints required while minimizing the amount of user interaction required. Finally, the user could place the card in a home printer 48 (FIG. 1A), and the printer could automatically produce the quantity of prints of each image required. In the last two cases, the size and quality of print types available might be limited to those available by the kiosk 16 or the home printer 48.

Alternately, the camera could incorporate or be connected to a wired or wireless modem, such as the communications interface 28 (FIG. 1A). In this case, the print order information, and the image information needed to fulfill the print order, would be transmitted to the service provider 14 along with the account information through the communication network 31 (which could be a wired or wireless network). The service provider 14 would print the order and mail the prints back to the user.

Instead of, or in addition to, composing a print order, the user may choose to transmit one or more images to others. These images can include the “creative” images and/or text described above. The user selects the images and the person(s) who will receive them, from the group of addresses loaded into the camera via the process described earlier (the software application running on the home PC 10). The e-mail order information is provided in the utilization file that gives the e-mail address and includes pointers to the image files that store the images required to “fulfill” the e-mail order.

If the camera includes a transmitter, e.g., a cellular connection in the communications interface 28, the camera could include and initiate a “send” command that the user would enable after completing the e-mail order. This command would automatically send the appropriate images to the appropriate user's e-mail accounts through the network 31 using the appropriate communications protocol (FTP, mailto, etc.). Alternately, the camera can be placed in a docking unit (not shown) containing the modem. The images can then be automatically transmitted to the service provider 14, when the camera is inserted into the dock. Alternately, the memory card 36 could be removed from the camera and placed in a kiosk, which would then transmit the images and bill the user's charge card.

Instead of, or in addition to, composing a print order and/or an e-mail order, the user may choose to transmit one or more images to their “electronic photo album” account, which could be maintained by the service provider 14 (or alternately could be maintained on the user's home computer 10) in image “album” storage 52. In this case, the user selects the images to be transferred to their photo album, and optionally selects what group of users might be allowed to view the images. The groups may include “Self only”, “Self plus immediate family only”, and “All” (family, friends, etc.) The information may include text, which may be input and selected as described in U.S. Pat. No. 5,633,678, “An Electronic Still Camera for Capturing and Categorizing Images”, filed Dec. 20, 1995, and assigned to the assignee of the present application, and which is incorporated herein by reference.

Instead of having the camera 12 communicate directly to the “downstream” service provider 14 over the communications network 31, the communications network 31 from the camera 12 could alternately be connected to an internet service provider (ISP) (not shown) such as AOL (America On Line), Earthlink, Eznet, etc. The “downstream” service provider 14 would then be connected to all ISPs via the internet, eliminating the need to maintain a separate communications network. The ISP would transfer the utilization file data and images needed to order prints and album images to the downstream service provider. The ISP could itself handle e-mailing of images to other users, using the data and images in the utilization file.

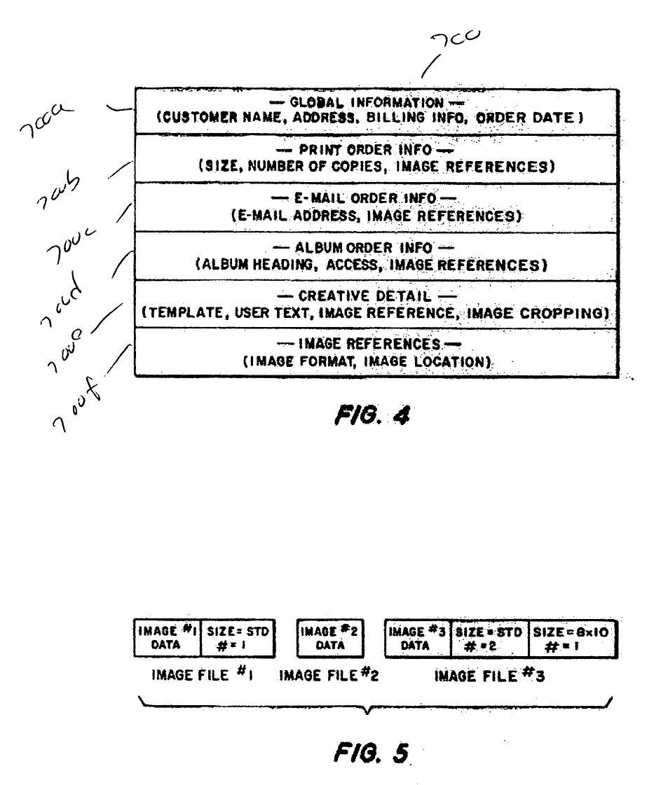

The utilization order information is provided in the utilization file. The general file organization 700 is shown in FIG. 4, and a detailed example of the file contents of an elaborate utilization file is given in Appendix I at the end of this specification. This file may be encrypted to prevent unauthorized use of the sensitive information, such as the user's credit card number. Referring to Appendix I and FIG. 4, a Global information section (Appendix I, lines 2-26) (FIG. 4, 700a) provides the customer information (name, address, credit card), as well as the time the order was placed, and whether it has been processed or not. File organization 700 can also include a print order information section 700b, an e-mail order information section 700c, an album order information section 700d, a creative detail information section 700e and image references 700f.

More specifically, the file may contain one or more Print Order sections that includes print order information 700b. For example, lines 28-37, Appendix I describe a print order of “standard” size (4″×6″) prints of the images made on a silver halide based CRT printer. Line 34, Appendix I indicates that two copies of the image referenced in line 33 will be printed, while only one copy of the images referenced in lines 35-36 is printed. A second print order section (lines 39-55) Appendix I indicates a large size print (24″×36″) should be made on a silver halide printer and mounted in particular in a walnut frame. This printer should be sent via UPS to the address shown in lines 47-52, Appendix I. The image is the composite shown in FIG. 3, which is described in the CreativeDetail section (lines 76-90) (Appendix I).

E-mail order section (Appendix I, lines 57-65) (FIG. 4, 700c) provides the e-mail address and a list of images that should be sent to this address.

Album order section (Appendix I, lines 67-72) (FIG. 4, 700d) provides a means for adding images to the users on-line photo album. The user can classify the images under a particular heading (e.g., “vacation” images) and indicate who is allowed to access the images via the internet.

Creative Detail section (Appendix I, lines 74-90) (FIG. 4, 700e) defines each creative image, such as the image in FIG. 3. It also describes user defined text (Appendix I, line 81). Multiple templates and user text options may be downloaded from the host computer to a memory card that is then inserted into the camera, prior to taking pictures. The template (background) may be an identification code that is only added, for example, during printing. In this case, the template is not viewed when the image is displayed on the camera. Alternately, a low resolution version of the templates desired by the user can be stored in the camera, so that the user can preview the final composite image. A high resolution version of the template can be used by the service provider to print the final composite image. The user may decide to crop and rotate the image (Appendix I, lines 86-87) prior to inserting it into the creative background.

Image detail or references section (Appendix I, 92-102) (FIG. 4, 700f) describes the file type (e.g., FlashPix, JPEG, TIFF) and location of each image. In this example, the three images are all FlashPix images located on the memory card “Local Card” in the “vacation” folder.

Most of the information in GlobalInfo and CreativeDetail sections of the digital camera utilization file, for example the addresses and creative text, is downloaded from the host computer to the camera prior to picture taking. After reviewing the images, the user uses the image LCD and user interface to select which images to print, e-mail, and album. The print size, e-mail, albuming, and creative options are offered by pull-down menus that match the options provided by the service providers they have selected on the computer and downloaded to the camera (via the card). The full utilization file (Print order, e-mail order, etc.) is then created by the camera based on the user selections.

A much simpler print utilization file is shown in Appendix II. In this case, the camera simply allows a print order to be created. The memory card 36 containing the images and the simple utilization file is then inserted into the home PC 10, the home printer, or the walk-up kiosk 16 or sent to a service provider via a communications interface. The proper number of each selected image is then automatically printed, without further user intervention.

Instead of providing the utilization information for multiple images in a single utilization file, other embodiments are possible. For example, the camera may create three utilization files, one containing the information needed to produce a print order, a second containing information needed to provide electronic albuming, and a third containing e-mail order information. Alternately, the utilization information may be provided with each image file, as shown in FIG. 5. In this embodiment, the print order information describing the number and size of each image to be printed is included in tags provided within each image file. For example, image file #1 contains the image data and a tag indicating that the user has requested one standard size print. Image file #2 does not contain a print tag (or alternately could include a tag with the number of prints set equal to zero) so no prints will be made of image #2. Image file #3 includes a first print tag indicating that the user has requested two standard size prints, and a second tag indicating that the user has also requested a single 8″×10″ size enlargement.

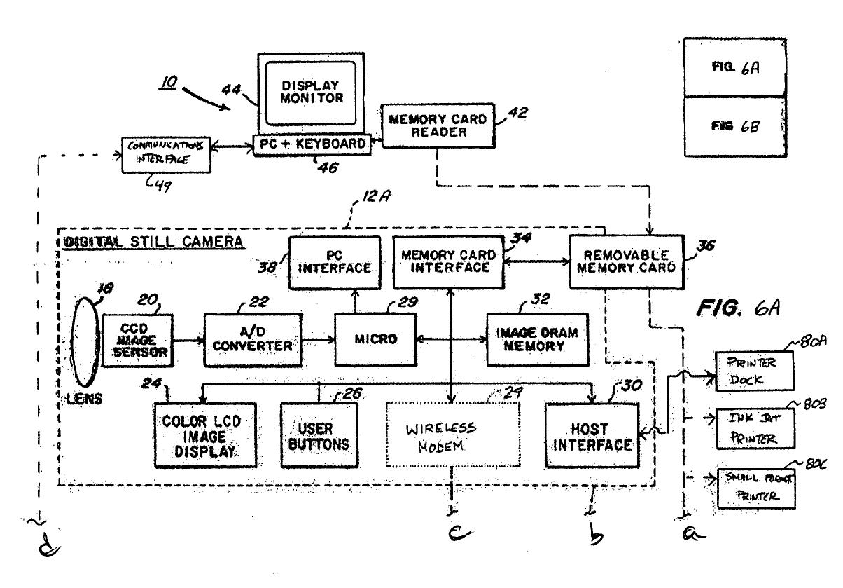

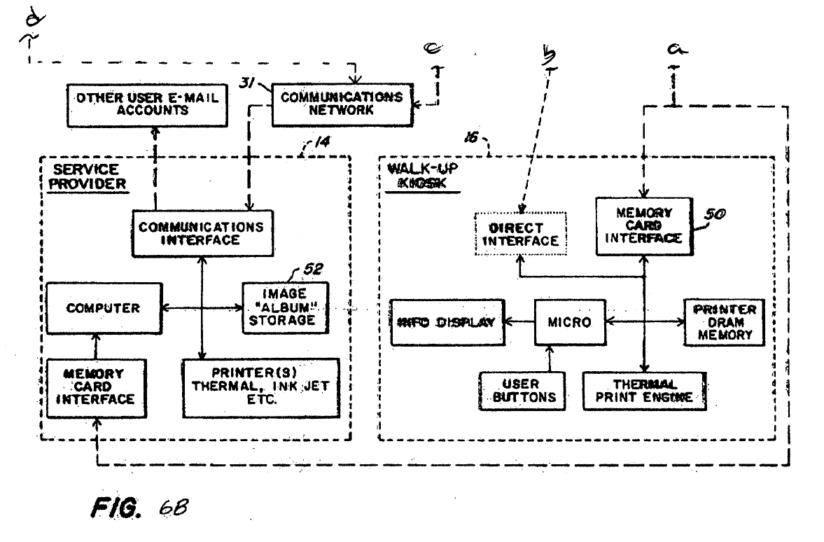

FIGS. 6A, 6B are a block diagram of another embodiment of a system according to the present invention. The system includes a digital camera 12A, as described earlier in reference to FIGS. 1A, 1B. Alternatively, the digital camera 12A could be part of a camera phone, PDA, digital camcorder, or the like. The system of FIGS. 6A, 6B also includes a walk-up kiosk printing system 16 (FIG. 6B) and a service provider 14 (FIG. 6B) which can provide prints using various printers, as described earlier in reference to FIGS. 1A, 1B.

The system of FIGS. 6A, 6B also includes a plurality of photo printers 80A, 80B, and 80C. Each of the photo printers 80A-C can be a different model printer, which has different capabilities. For example, printer 80A can be a Kodak Easyshare printer dock, available from Eastman Kodak Company in Rochester, New York, that produces 4″×6″ prints and offers some special image processing features, but does not produce larger size prints. The printer dock 80A connects to the host interface 30 of the digital camera 12A when the digital camera 12A is placed on top of the dock printer 80A.

Printer 80B can be an ink jet printer capable of producing letter-size prints as well as 4″×6″ prints, such as the HP Photosmart 8450 Printer, available from Hewlett-Packard Corporation in Palo Alto, Calif. Ink jet printer 80B can include a memory card interface (not shown) which receives the removable memory card 36 and an interface, such as a USB interface, which connects with the host interface 30 of the digital camera 12A.

Printer 40C can be a small format inkjet photo printer, such as the HP model 7450, which makes prints up to 4″×6″ in size. Small format ink jet printer 80C can also include a memory card interface (not shown) which receives the removable memory card 36 and an interface, such as a USB interface, which connects with the host interface 30 of the digital camera 12A.

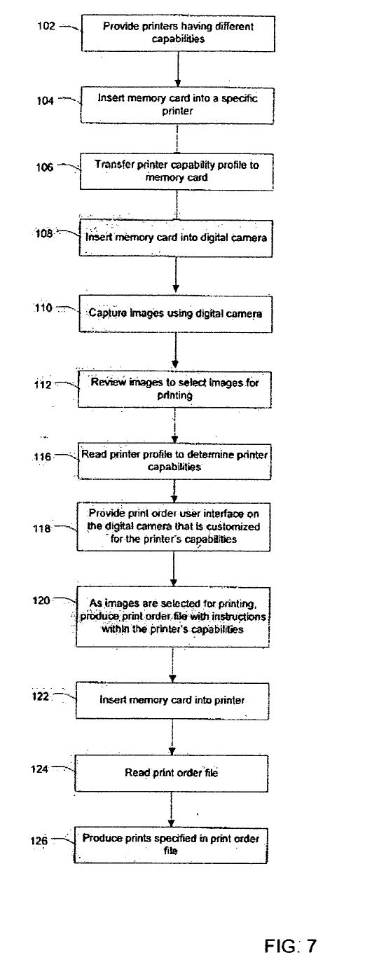

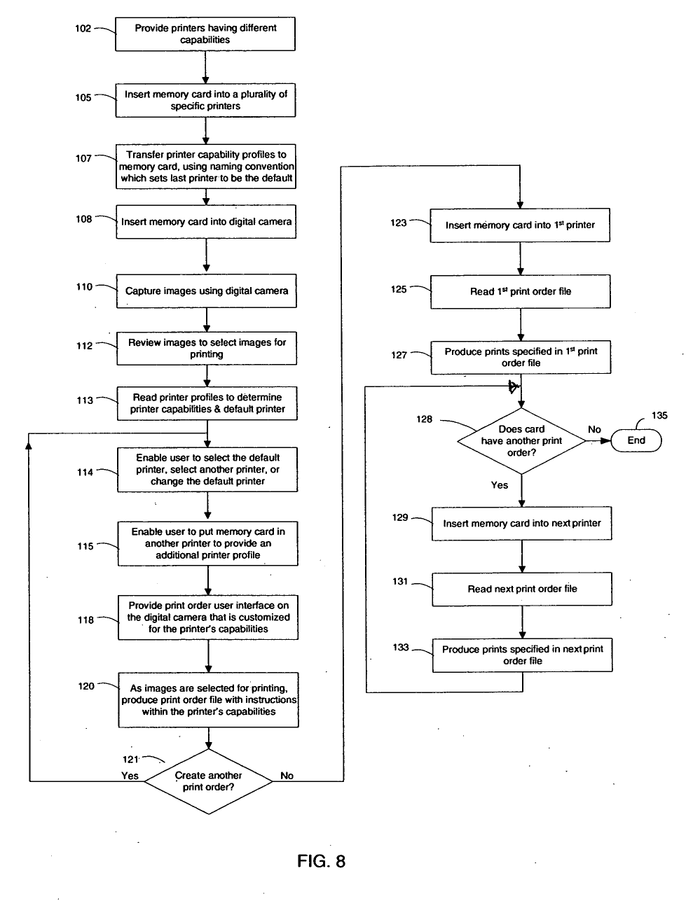

The different capabilities of the printers 80A-C, the kiosk printing system 16, and the service provider printers can be specified using a printer capability profile for that particular printing system, as will be described later in reference to FIG. 7 and FIG. 8. In some embodiments, the camera 12A can include a wireless modem 29, which can communicate via the communications network 31 (such as a mobile telephone network) with the service provider 14. In this case, capabilities of the service provider can be communicated to the camera 12A, so that they can be stored and later used to create a customized print order for prints to be made by the service provider. The service provider 14 can print the customized print order and mail the prints back to the user.

In some embodiments, the printing capabilities of the service provider 14 can be transferred to the digital camera 12A by having the service provider 14 provide a printer capability profile to the host PC system 10. The host PC system 10, which includes the PC+ keyboard 46 and the display monitor 44, uses the communications interface 49 to receive the printer capability profile from the service provider 14 via the communications network 31, which can be the Internet. The printer capability profile can then be transferred to the digital camera 12A by using the memory card reader 42 to write the profile to the removable memory card 36, which is then inserted into the digital camera 12A.

In some embodiments, the digital camera 12A can connect with a docking unit (not shown) containing a wired or wireless modem, which communicates with the service provider 14 in order to obtain the printer capability profile, and in order to transfer the customized print order and the images to the service provider.

FIG. 7 is a flow diagram of a first embodiment of a method for producing print order file files customized for a particular printer. In this embodiment, the printer specific information, such as the output media type and sizes supported by the printer, and the types of image enhancements supported, are transferred from the printer to the camera by storing a printer profile on the removable memory card 36. This enables the generation of enhanced print orders directly from the camera 12A. These enhanced print orders are customized for the particular printer associated with the printer profile.

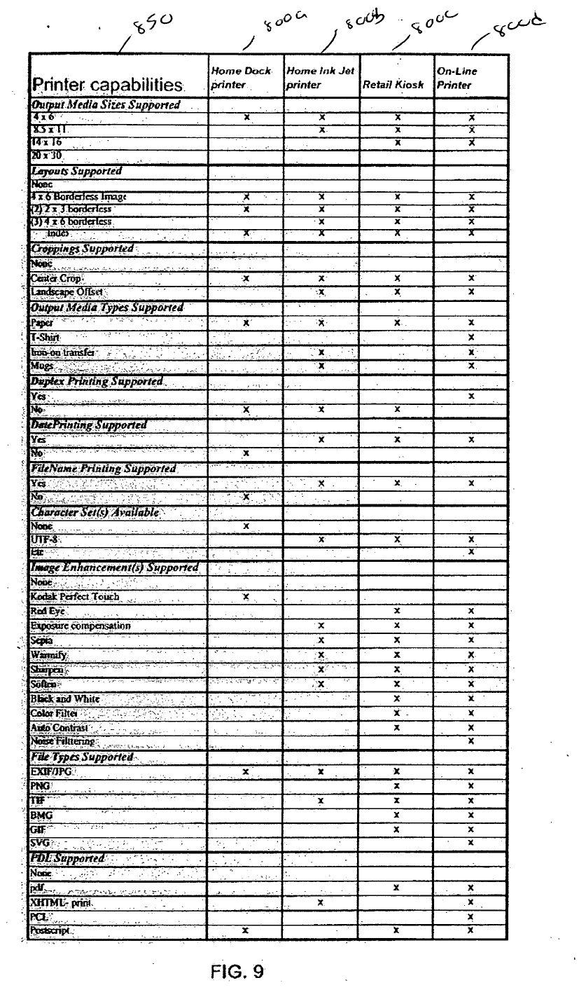

In block 102, a plurality of different printers having different capabilities are provided. FIG. 9 is an example of the printer capabilities that can be provided by four different printing systems shown in columns 800a, 800b, 800c, 800d. Printer features are listed in the first column 850. These include Output Media Sizes Supported, Layouts Supported, etc. The remaining columns 800a-800d indicate which printer capabilities are available using the four different printers, including the home dock printer 80A, which is a dedicated small format photo printer, the home ink jet printer 80B, the retail walk-up kiosk 16, and the on-line service provider 14. For example, it is shown that the dock printer 80A only supports 4″×6″ output media, the home ink jet printer 80B supports 4″×6″ and 8.5″×11″ output media sizes, and the on-line service provider 14 supports all of the media sizes listed. As another example, the dock printer 80A supports only Kodak Perfect Touch for image enhancements, whereas the on-line service provider 14 supports many other enhancements such as red eye removal, exposure compensation, sepia tones, etc. In general, the dedicated dock printer 80A, being a simple photo printer, has the most limited capabilities. The home ink jet printer 80B provides significantly increased features, while the on-line service provider 14 supports most of the listed features.

In block 104, the removable memory card 36 is inserted into the card reader of a printer enabled for stand-alone printing, for example dock printer 80A or ink jet printer 80B. The printer 80 determines whether there is a printer profile already stored on the removable memory card 36. If so, it determines (for example, from the name of the profile) whether it corresponds to the same model printer. If there is no profile for the current model printer, the printer profile from the particular printer is stored on the memory card.

The printer profile can be stored, for example, in a XML file named PRINTERNAME.ppf, where PRINTERNAME is the make and model number of the printer. The XML file indicates which of the features in table 1 are supported by the particular printer. Alternatively, the printer profile can be an ASCII text file.

As described earlier, to provide a printer profile for online printing services, an appropriate profile can be downloaded directly to the digital camera 12A over the communications network 31 via the wireless modem 29, or through the host PC 10 using memory card reader 42. In alternative embodiments, it is possible to directly connect the camera to the printer, using host interface 30 (which may be provided using the USB interface) and for the digital camera 12A to store the profile on the removable memory card 36 using memory card interface 34.

In block 108, the memory card is inserted back into digital camera 12A, so that the printer profile can be accessed by the micro 29.

In block 110, the digital camera 12A is used to capture and store digital images. This is typically done at location remote from the printer. For example, the user may be outdoors, away on vacation, etc.

In block 112, the color LCD image display 24 is used to review images captured by the digital camera 12. The user buttons 26 are used to select images for printing. Again, this is typically done at a location remote from the printer.

At this point, in block 116, the camera reads the printer profile stored on the removable memory card 36, in order to determine the capabilities of the particular printer associated with the printer profile.

In block 118, the user can then select any of the capabilities offered by the particular printer. Depending on the capabilities of the printer, as indicated in the printer profile, and the capabilities of the digital camera 12A, the print order user interface can provide different options to the user. These options allow the user to select printer specific capabilities, based on the printer capabilities profile.

As images are selected for printing, the print order is produced with instructions within the printer's capabilities.

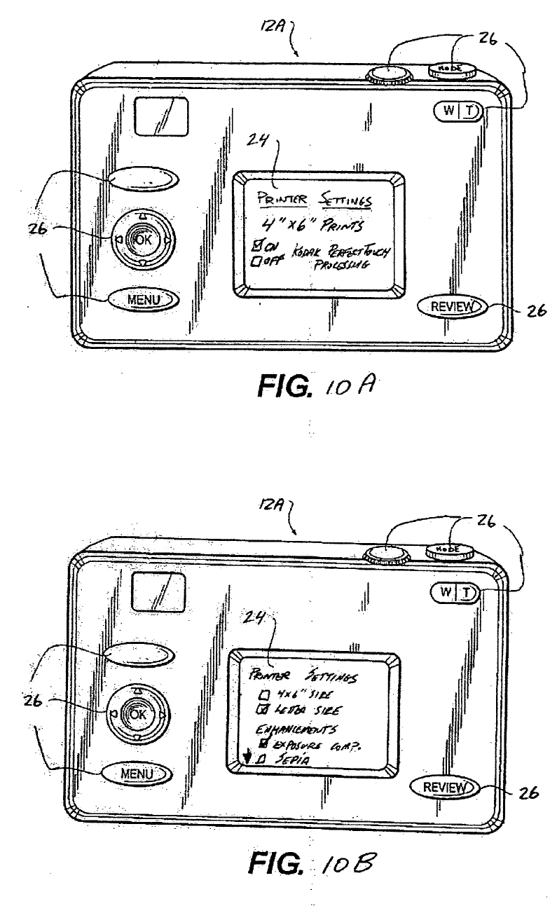

The user interface displayed on the color LCD image display 24 of the digital camera 12 is customized to enable the user to select the printer capabilities provided in the printer capabilities profile. For example, as shown in FIGS. 10A-10B, two different user interfaces are provided for two different printers. FIG. 10A depicts some of the information displayed on the color LCD image display 24 of the digital camera 12A when the printer capabilities profile of the home dock printer 80A is used. The printer settings always provide 4″×6″ prints, since this is the only output size that is supported by the dock printer 80A, as indicated in FIG. 9. The user interface in FIG. 10A enables the user to select whether or not to use “Kodak PerfectTouch” processing, by selecting either the “ON” or “OFF” box using the 4-way/“OK” selector, which is one of the user controls 26.

FIG. 10B depicts some of the information displayed on the color LCD image display 24 of the digital camera 12A when the printer capabilities profile of the ink jet printer 80B is used. Because two different output media sizes are supported, the user interface enables the user to select either 4″×6″ size prints or letter (8.5″×11″) size prints, since these are the output sizes that are supported by the ink jet printer 80B, as indicated in FIG. 9. The user interface in FIG. 10B enables the user to select the desired print size and printing enhancements (such as exposure compensation, sepia, etc.) by selecting the appropriate box using the 4-way/“OK” selector.

Referring back to FIG. 7, in block 120 the complete customized print order file is created in the digital camera 12A, and stored on the removable memory card 36.

In block 122, the memory card 36 is inserted into the particular printer, such as dock printer 80A or ink jet printer 80B. This typically happens at some future time, when the user is again in the same location as the printer.

In block 124, the particular printer reads the customized print order file. If the printer configuration profile corresponding to the dock printer 80A was used to create the customized print file, then all of the prints in the print order will have a standard (4″×6″_media size. But if the printer configuration profile corresponding to the ink jet printer 80B was used to create the customized print file, then some or all of the prints in the print can use letter size (8.5″×11″) media.

In block 126, the printer produces the prints specified in the customized print order file. The advantage of the invention is that the print order file can utilize the printer capabilities of each of the printers 80A, 80B, 14, and 16 that were described in reference to FIG. 9.

FIG. 8 is a flow diagram of a second embodiment of a method for producing print order files customized for a particular printer. In this embodiment, the process of transferring printer capability profiles is repeated several times for several different printers that the user intends to utilize. This enables the camera to store a plurality of printer capability profiles. In addition, a naming convention is implemented which sets the last printer as the default. The digital camera 12A can then produce several different customized print order files, to take advantage of the capabilities of the different printers that the user wishes to use. This enables the user, for example, to produce some standard size prints at home, using a dock printer 80A, and to produce larger prints or other photo products, such as mugs, t-shirts, etc., using the retail walk-up kiosk 16 or the Internet service provider 14.

As described earlier in reference to FIG. 7, in block 102 a plurality of different printers are provided as described in reference to FIG. 6.

In block 105, the removable memory card 36 is inserted into the card reader of a first specific printer enabled for stand-alone printing, for example dock printer 80A, and then into the card reader of additional specific printers, such as ink jet printer 80B. This enables the removable memory card 36 to store a plurality of printer capability profiles; for example as separate XML files named with the make and model of the specific printers. In addition, a master printer profile XML file could be used to indicate what directories and file names are used to store the multiple printer profiles, and which one should be used as the default. The default could be the last profile stored, unless a different profile was selected by the user, as will be described later in reference to block 114.

As described earlier in reference to block 108, the removable memory card 36 is inserted back into digital camera 12A, so that the printer capabilities profile can be accessed by the micro 29.

In block 110, the digital camera 12A is used to capture and store digital images.

In block 112, the color LCD image display 24 is used to review images captured by the digital camera 12A. The user buttons 26 are used to select images for printing.

In block 113, the digital camera 12A reads the printer profile master file stored on the removable memory card 36, in order to locate the printer profiles and determine the default printer profile. Each printer profile is then read, in order to determine the printer capabilities.

In block 114, the user can select a default printer, select another printer or change the default printer. It is possible that the user will want to use a different printer, which does not correspond to one of the printer profiles previously stored on the removable memory card 36. In this case, in block 115 the user puts the removable memory card 36 into that different printer, in order to transfer the printer capabilities profile to the digital camera 12A using the removable memory card 36.

In block 118 the print order interface is provided on the digital camera that is customized for the printer's capabilities. This permits the user to then select any of the capabilities offered by the particular printer, as described earlier in reference to FIG. 7.

In block 120, as images are selected for printing, the print order file with instructions within the printer's capabilities is produced. Therefore, the complete customized print order file is created in the digital camera 12A, and stored on the removable memory card 36.

In block 121, the user is asked whether they want to create another print order, customized for the capabilities of another or a second printer. For example, the first print order may be customized for the dock printer 80A, in order to produce 4″×6″ sized prints in their home, while the second print order may be customized for the on-line service provider 14, in order to produce large prints, t-shirts, etc.

If the user wants to create another print order (yes to 121), blocks 114 through 120 are repeated. If the user does not want to create another print order (no to 121), in block 123 the removable memory card 36A is inserted into the first printer, for example dock printer 80A. Again, this typically happens at some future time, when the user is again in the same location as the printer.

In block 125, the first particular printer, such as dock printer 80A, reads the print order file which has been customized for it.

In block 127, the first printer, such as dock printer 80A, produces the prints specified in the first customized print order file, while ignoring the second print order file, which was customized for a different printer.

In block 128, the user is asked if the memory card has another print order. If the answer to bock 128 is no, the process is ended at step 135. If the answer to block 128 is yes, the process proceeds to block 129.

In block 129, the removable memory card 36 is inserted into the second printer or printing system, for example into memory card reader 42 of the host computer 10 or the memory card interface 50 of the walk-up kiosk 16.

In block 131, the second printer or printing system reads the print order file that has been customized for it. For example, the host computer 10 can read the print order that was customized for the online service provider 14, and transfer the required images and printer order to the service provider 14 over the communications network 31.

In block 133, the second printer produces the prints specified in the first customized print order file, while ignoring the first print order file, which was customized for a different printer. For example, the online service provider 14 can produce the prints and other photo products (mugs, t-shirts, etc.) in the print order and ship them to the customer. After block 133, the process goes back to block 128, where it is determined if the card has further print orders. If yes to block 128, the process continues with blocks 129-133 and block 128 as noted above, until the answer to block 128 is no, whereby the process ends at step 135.

The invention has been described with reference to a preferred embodiment. However, it will be appreciated that variations and modifications can be effected by a person of ordinary skill in the art without departing from the scope of the invention.

APPENDIX I
DIGITAL CAMERA UTILIZATION FILE

1 00000000 UTILIZATION ORDER SPECIFICATION (Non-zero initial number identifies
encryption key)
2 %Section: GlobalInfo
3 %Section: ConsumerInfo (Provides info on camera owner and default mailing
address)
4 %Name: ˜Smith˜˜John˜˜W˜
5 %Consumer ID: Njj1007

| 6 %Address: | ˜1 Picture Avenue˜ |
|---|---|
| 7 | ˜Apartment 8b˜ |
| 8 | ˜PO Box 123˜ |
| 9 | ˜Anytown˜ |
| 10 | ˜State˜ |

11 %PostalCode:˜14650˜
12 %CountryCode:USA
13 %Email:˜jdoe@kodak.com˜
14 %PhoneDay: ˜(716) 555-1111˜
15 %PhoneNight: ˜(716) 555-2222˜
16 %CreditCardExpDate: 1996 03 24
17 %CreditCardNumber: 3030445643345
18 %CreditCardType: AmericanExpress
19 %EndSection: ConsumerInfo
20
21 %Section: OrderInfo (Provides information on when utilization file was
created)
22 %Date: 1996 2 28
23 %Time: 14 22 29
24 %Processed: 0 (1 Indicates that this utilization order was
processed)
25 %EndSection: OrderInfo
26 %EndSection: GlobalInfo
27
28 %Section: PrintOrder (Lists the images in a print order)
29 %Section: FinishInfo
30 %ImageOutputSize: 4 6 Inches (This example is for standard size
prints)
31 %MediaClass: AgX 20 EN34 Glossy
32 %EndSection: FinishInfo
33 %ImageRef: ImageDetaill (Points to images defined below)
34 %Quantity:2 (Optionally indicates number of copies, default=1)
35 %ImageRef: ImageDetail2
36 %ImageRef: ImageDetail3
37 %EndSection: PrintOrder
38
39 %Section: PrintOrder
40 %Section: FinishInfo
41 %ImageOutputSize: 24 36 Inches (This example is for a large
creative print)
42 %MediaClass: AgX 20 EN34 Glossy
43 %FrameType: F134 Walnut
44 %EndSection: FinishInfo
45 %Section: ShippingInfo (Instructions to ship to an address other than the
one in GlobalInfo)
46 %ShippingCarrier: UPS
47 %Name: ˜Good˜˜Johnny˜˜B˜

| | |
|---|---|
| 48 %Address: | ˜1 Song Street˜ |
| 49 | ˜Mytown˜ |
| 50 | ˜State˜ |

51 %PostalCode: ˜00111˜
52 %CountryCode: USA
53 %EndSection: ShippingInfo
54 %ImageRef: CreativeDetail1 (Points to creative defined below)
55 %EndSection: PrintOrder
56
57 %Section: EmailOrder (Sends images via e-mail)
58 %Section: AddressInfo (Instructions to ship to an address other than the
one in GlobalInfo)
59 %Name: ˜Good˜˜Johnny˜˜B˜
60 %Email: ˜jgood@localnet.net˜
61 %EndSection: AddressInfo
62 %ImageRef: Creative Detail1 (Points to creative defined below)
63 %ImageRef: ImageDetail2
64 %ImageRef: ImageDetail3
65 %EndSection: EmailOrder
66
67 %Section: AlbumOrder (Add these images to on-line photo album)
68 %AlbumHeading: ˜Vacation images˜ (Place images under “vacation” album
heading)
69 %AlbumViewing: All (gives access to all authorized album viewers)
70 %ImageRef: CreativeDetail1 (Points to creative defined below)
71 %ImageRef: ImageDetail2
72 %EndSection: AlbumOrder
73
74 %Section: CreativeDetail 1 (Describes each composite image)
75
76 %LayoutRef: T12345 (Indicates template ID or template image file)
77 %Section: PageInfo
78 %PageRef: 0
79 %Section: TextInfo (Indicates what text appears in the template)
80 %TextNodeRef: 1
81 %ConsumerText: ˜Hi, I'm having a relaxing time on vacation.
John Smith
82 %EndSection: TextInfo
83 %Section:ImageInfo (Indicates which images(s) appear in
template)
84 %ImageNodeRef: 2
85 %ImageDetailRef: 1
86 %CropRect: 256 0 768 1280 (Cropped image top, left, width,
height)
87 %Rotate: 90 (Indicates rotation in degrees clockwise)
88 %EndSection: ImageInfo
89 %EndSection: PageInfo
90 %EndSection: CreativeDetail
91
92 %Section: ImageData (Describes each image, may be referenced multiple times)
93 %Section: ImageDetail 1
94 %FileType: FlashPix Version 2.0
95 %ImageLocation: LocalCard˜Vacation/Image4.FPX˜
96 %Section: ImageDetail 2
97 %FileType: FlashPix Version 2.0
98 %ImageLocation: LocalCard˜Vacation/Image7.FPX˜
99 %Section: ImageDetail 3
100 %FileType: FlashPix Version 2.0
101 %ImageLocation: LocalCard˜Vacation/Image10.FPX˜
102 %EndSection: ImageData

APPENDIX II
SIMPLE PRINT ORDER UTILIZATION FILE

| 1 | % Section: PrintOrder | | (Lists the images in a print order) |
|---|---|---|---|
| 2 | Image4.FPX | 1 | (One copy of image 4) |
| 3 | Image7.FPX | 2 | (Two copies of image 7) |
| 4 | Image10.FPX | 1 | |
| 5 | Image12.FPX | 4 | |
| 6 | Image13.FPX | 1 | |

| | |
|---|---|
| 7 | % EndSection: PrintOrder |

1. A method for producing prints using a digital printer from images captured using a digital camera, comprising:
(a) providing a digital printer having specific printing capabilities;
(b) producing a profile defining the printing capabilities of the digital printer
(c) storing the profile in the digital printer
(d) transferring the profile from the digital printer to the digital camera using a removable storage device.
(e) capturing images using the digital camera and storing the captured images on the removable storage device
(f) using the digital camera to produce a print order using at least one printer capability of the digital printer.
(g) storing the print order on the removable storage device
(h) transferring the removable storage device from the digital camera to the digital printer; and
(i) printing the print order on the digital printer.

2. The method as claimed in claim 1 wherein the digital camera includes a mobile phone.

3. The method as claimed in claim 1 wherein the digital camera includes a PDA.

4. The method as claimed in claim 1 wherein the printer capability includes a print size.

5. The method as claimed in claim 1 wherein the printer capability includes an image processing enhancement.

6. The method as claimed in claim 1 wherein the printer is a retail kiosk.

7. The method as claimed in claim 1 wherein the printer is an on-line printing service

8. The method as claimed in claim 1 further comprising storing the printing capabilities using an XML file.

9. The method as claimed in claim 1 further comprising displaying the printer capabilities on a display of the digital camera.

10. A method for producing prints from images captured by a digital camera, the method using at least a first digital printer and a second digital printer, the second digital printer having different capabilities than the first digital printer, the method comprising:
(a) producing a first profile defining printing capabilities of the first digital printer and a second profile defining printing capabilities of the second digital printer;
(b) storing the first and second profiles in the digital camera;
(c) capturing and storing images using the digital camera;
(d) using the digital camera and the first and second profiles to produce a first print order for the first digital printer and a second print order for the second digital printer;
(e) using the first print order to produce prints using the first printer; and
(f) using the second print order to produce prints on the second printer.

11. The method as claimed in claim 10 further comprising storing the printing profiles using XML files.

12. The method as claimed in claim 10 further comprising displaying the printer capabilities of the first printer and the second printer on a display of the digital camera.

13. The method as claimed in claim 1 wherein the digital camera includes a mobile phone.

14. The method as claimed in claim 10 wherein the printer capability includes a print size.

15. The method as claimed in claim 10 wherein the printer capability includes an image processing enhancement.

16. The method as claimed in claim 10 wherein the printer is a retail kiosk.

17. The method as claimed in claim 10 wherein the printer is an on-line printing service.

18. A method for producing prints at a service provider using images captured by a digital camera and transferred over a communications network to the service provider, comprising:
(a) providing a digital camera having a modem for communicating with a service provider over the communications network;
(b) the service provider using the communications network to communicate the printing capabilities of a digital printer to the digital camera;
(c) capturing a digital image using the digital camera;
(d) using the printing capabilities of the digital printer to create a print order in the digital camera;
(e) communicating the digital image and the print order to the service provider; and
(f) using the digital printer to produce a print of the digital image specified in the print order.

19. The method as claimed in claim 18, wherein the printing capabilities of the digital printer include at least one print size.

20. The method as claimed in claim 19, wherein the printing capabilities of the digital printer include a plurality of print sizes, and wherein the print order identifies a specific print size from the plurality of print sizes.
